(19) United States
(12) Patent Application Publication
(10) Pub. No.: US 2019/0301501 A1
(43) Pub. Date: Oct. 3, 2019

(54) TELESCOPIC STRUCTURE

(71) Applicant: Caiye ZHU, SHANGQIU (CN)

(72) Inventor: Caiye ZHU, SHANGQIU (CN)

(21) Appl. No.: 16/157,758

(22) Filed: Oct. 11, 2018

(30) Foreign Application Priority Data
Apr. 3, 2018 (CN) 201820460937.0

(51) Int. Cl. F16B 7/10

(52) U.S. Cl. CPC F16B 7/10

(57) ABSTRACT

A telescopic structure is provided in the disclosure, which comprises: a lower cover, an upper cover, a linkage shaft, a ring provided to an outer side of the lower cover, a motor provided to an inner side of the lower cover. The linkage shaft is provided to an end of the motor, a telescopic ring is provided to an end of the linkage shaft, a guiding post is provided above the telescopic ring, a fixing block is provided above the guiding post, the upper cover is provided above the fixing block, and the ring is further provided to an outer side of the upper cover. The telescopic structure has the beneficial effects that it is telescopic, simple in structure, o convenient to operate and efficient in use.

### CROSS-REFERENCE TO RELATED APPLICATIONS

This application is claims priority to Chinese Patent Application No. 201820460937.0 with a filing date of Apr. 3, 2018. The content of the aforementioned application, including any intervening amendments thereto, is incorporated herein by reference.

### TECHNICAL FIELD

The disclosure relates to the technical field of telescopic rod, and particularly to a telescopic structure.

### BACKGROUND OF THE PRESENT INVENTION

At present, most of the telescopic rods available in the market are in metal structure, which are heavy, costly, and generate heat and cause serious wear during move telescopically. Therefore, a telescopic structure that is convenient to use with low cost is needed.

### SUMMARY OF PRESENT INVENTION

An object of the disclosure is to provide a telescopic structure to solve the problems above.

The object is realized by the following technical solutions:

A telescopic structure comprises: a lower cover, an upper cover, a linkage shaft, a ring, a motor, a telescopic ring, a guiding post and a fixing block; the ring is provided to an outer side of the lower cover, the motor is provided to an inner side of the lower cover, the linkage shaft is provided to an end of the motor, the telescopic ring is provided to an end of the linkage shaft the guiding post is provided above the telescopic ring, the fixing block is provided above the guiding post, the upper cover is provided above the fixing block, and the ring is further provided to an outer side of the upper cover.

In the above structures, the motor drives the linkage shaft to rotate, and then drives the telescopic ring, the guiding post, the fixing block and the ring to move telescopically. The principle of the telescopic structure is that the guiding post cooperates with a guiding groove defined on the linkage shaft to move telescopically, and then a direction of the telescopic ring is fixed by slots defined on the upper and lower plastic cover, so as to function as a telescopic structure.

In order to further improve the function of the telescopic structure, the upper cover and the lower cover are connected by screws, the upper cover is made of plastic and the lower cover is made of plastic.

In order to further improve the function of the telescopic structure, the motor is embedded between the upper cover and the lower cover.

In order to further improve the function of the telescopic structure, the motor is coaxially connected to the linkage shaft, and the linkage shaft is made of plastic.

In order to further improve the function of the telescopic structure, the linkage shaft is coupled with the telescopic ring, and the telescopic ring is made of plastic.

In order to further improve the function of the telescopic structure, the guiding post is coupled with the telescopic ring, and the guiding post is made of a zinc alloy.

In order to further improve the function of the telescopic structure, the fixing block is coupled with the guiding post, the fixing block is coupled with the upper cover, the fixing block is made of plastic, the ring is sleeved on the upper cover and the lower cover, and the ring is made of plastic.

The telescopic structure has the beneficial effects that it is telescopic, simple in structure, o convenient to operate and efficient in use.

### DESCRIPTION OF THE DRAWINGS

FIG. 1 is an explosive view of a telescopic structure according to the present disclosure.

The reference characters are as follows:

1, a ring; 2, an upper cover, 3, a motor, 4, a linkage shaft; 5, a fixing block; 6, a fixing block; 7, a telescopic ring; and 8, a lower cover.

### DETAILED DESCRIPTION OF PREFERRED EMBODIMENTS

The present disclosure is further described below with reference to the drawings.

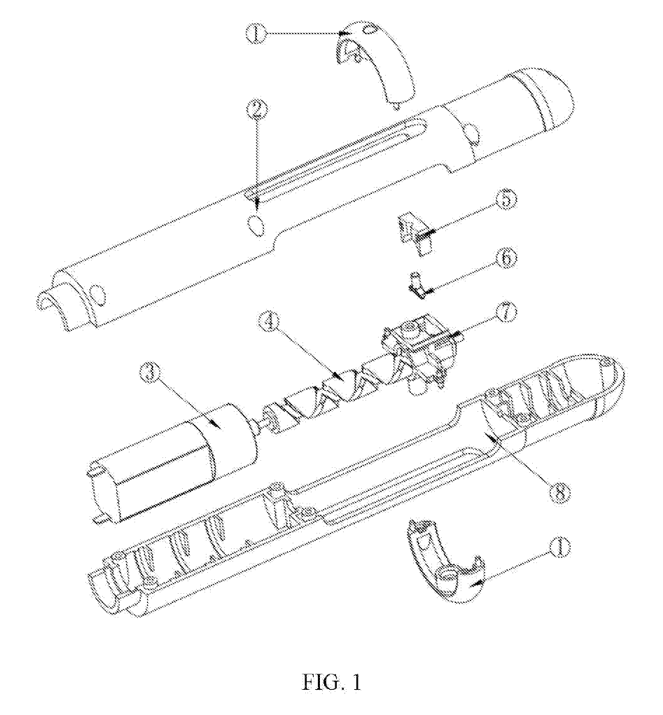

Referring to FIG. 1, a telescopic structure comprises: a lower cover 8, an upper cover 2, a linkage shaft 4, a ring 1, a motor 3, a telescopic ring 7, a guiding post 6 and a fixing block 5. The ring 1 is provided to an outer side of the lower cover 8, the lower cover 8 is configured to carry and protect the components, and the ring 1 is configured to move telescopically. The motor 3 is provided to an inner side of the lower cover 8, and the motor 3 is configured to generate power. The linkage shaft 4 is provided to an end of the motor 3, and the linkage shaft 4 is configured to transmit power. The telescopic ring 7 is provided to an end of the linkage shaft 4, and the telescopic ring 7 is configured to move telescopically. The guiding post 6 is provided above the telescopic ring 7, and the guiding post 6 is configured to guide the movement. The fixing block 5 is provided above the guiding post 6, and the fixing block 5 is configured to move telescopically. The upper cover 2 is provided above the fixing block 5, and the upper cover 2 is configured to carry and protect the components. The ring 1 is further provided to an outer side of the upper cover 2.

In the above structures, the motor 3 drives the linkage shaft 4 to rotate, and then drives the telescopic ring 7, the guiding post 6, the fixing block 5 and a ring 1 to move telescopically. The principle of the telescopic structure is that the guiding post 6 cooperates with a guiding groove defined on the linkage shaft 4 to move telescopically, and then a direction of the telescopic ring 7 is fixed by slots defined on the upper and lower plastic cover 8, so as to function as a telescopic structure.

In order to further improve the function of the telescopic structure, the upper cover 2 and the lower cover 8 are connected by screws, the upper cover 2 is made of plastic and the lower cover 8 is made of plastic. The motor 3 is embedded between the upper cover 2 and lower cover 8. The motor 3 is coaxially connected to the linkage shaft 4, and the linkage shaft 4 is made of plastic. The linkage shaft 4 is coupled with the telescopic ring 7, and the telescopic ring 7 is made of plastic. The guiding post 6 is coupled with the telescopic ring 7, and the guiding post 6 is made of a zinc alloy. The fixing block 5 is coupled with the guiding post 6, the fixing block 5 is coupled with the upper cover 2, and the fixing block 5 is made of plastic. The ring 1 is sleeved on the upper cover 2 and the lower cover 8, and the ring 1 is made of plastic.

The basic principles, main features and advantages of the invention have been shown and described above. It should be understood by those of ordinary skill in the art that the present invention should not be limited by embodiments described above. What described in the embodiments and specification is to illustrate the principles of the invention, and there are various changes and modifications to these embodiments without departing from the spirit or scope of the invention, which should fall in the scope of the invention claimed.

I claim:

1. A telescopic structure, comprising: a lower cover (8), an upper cover (2), a linkage shaft (4), a ring (1) arranged on an outer side of the lower cover (8), a motor (3) arranged at an inner side of the lower cover (8), a telescopic ring (7) arranged at an end of the linkage shaft (4), a guiding post (6) arranged above the telescopic ring (7) and a fixing block (5) arranged above the guiding post (6), wherein the upper cover (2) is provided above the fixing block (5), and the ring (1) is further arranged on an outer side of the upper cover (2).

2. The telescopic structure according to claim 1, wherein the upper cover (2) and the lower cover (8) are connected by screws, the upper cover (2) is made of plastic and the lower cover (8) is made of plastic.

3. The telescopic structure according to claim 1, wherein the motor (3) is embedded between the upper cover (2) and the lower cover (8).

4. The telescopic structure according to claim 1, wherein the motor (3) is coaxially connected to the linkage shaft (4), and the linkage shaft (4) is made of plastic.

5. The telescopic structure according to claim 1, wherein the linkage shaft (4) is coupled with the telescopic ring (7), and the telescopic ring (7) is made of plastic.

6. The telescopic structure according to claim 1, wherein the guiding post (6) is coupled with the telescopic ring (7), and the guiding post (6) is made of a zinc alloy.

7. The telescopic structure according to claim 1, wherein the fixing block (5) is coupled with the guiding post (6), the fixing block (5) is coupled with the upper cover (2), the fixing block (5) is made of plastic, the ring (1) is sleeved on the upper cover (2) and the lower cover (8), the ring (1) is made of plastic.
